(19) United States
(12) Patent Application Publication
(10) Pub. No.: US 2014/0031061 A1
(43) Pub. Date: Jan. 30, 2014

(54) Systems And Methods For Monitoring Device And Vehicle

(71) Applicant: 52APPS, Columbia, SC (US)

(72) Inventors: Christopher James Thibault, Lexington, SC (US); Brendan Anthony Lee, Columbia, SC (US); Alan Gabriel Will, Irmo, SC (US); Drew Bryant Heavner, Columbia, SC (US); William Joseph Brower, Columbia, SC (US); Robert Andrew Askins, Columbia, SC (US); William Kirkland, Irmo, SC (US); Stephen A. Leicht, Lexington, SC (US)

(21) Appl. No.: 13/953,499

(22) Filed: Jul. 29, 2013

Related U.S. Application Data
(60) Provisional application No. 61/741,807, filed on Jul. 27, 2012.

(51) Int. Cl. H04W 4/02

(52) U.S. Cl. CPC H04W 4/027
USPC 455/456.1

(57) ABSTRACT

Methods and systems for monitoring a device and a vehicle associated with the device are provided. An example method can comprise monitoring a behavior of a first device in a vehicle, collecting the data associated with the behavior of the first device, and transmitting the data to a second device remote from the vehicle. In an aspect, the first and second device can be a mobile device such as a cell phone, smart phone, PDA, tablet, computer or the like. As an example, the behavior of the device can comprise at least one of a speed, an acceleration, a location, and an orientation, a user authentication, a type of use, and a time of use, whether the device is actively used while device is moving, etc.

### CROSS REFERENCE TO RELATED PATENT APPLICATION

This application claims priority to U.S. Provisional Application No. 61/741807 filed on Jul. 27, 2012, herein incorporated by reference in its entirety.

### BACKGROUND

A growing number of populations have access to mobile devices such as cell phone, smartphone, tablet, PDA etc. Many users of these mobile devices use mobile devices while operating a mobilized vehicle. Using mobile devices while operating a mobilized vehicle increases the risk of an accident. Actively using a mobile device such as talking, text-messaging or playing video games while operating a mobilized vehicle is prohibited by many states. There is a need for a more sophisticated systems and methods to monitor the behavior of a mobile device and a vehicle in which the device is used.

### SUMMARY

It is to be understood that both the following general description and the following detailed description are exemplary and explanatory only and are not restrictive, as claimed. Provided are methods and systems for monitoring a device and a vehicle associated with the device. An example method can comprise monitoring a behavior of a first device in a vehicle, collecting the data associated with the behavior of the first device, and transmitting the data to a second device remote from the vehicle. In an aspect, the first and second device can be a mobile device such as a cell phone, smart phone, PDA, tablet, computer or the like. In an aspect, the behavior of a device can comprise one or more of a motion behavior and a state of use behavior. As an example, the motion behavior can comprise at least one of a speed, an acceleration, a location, and an orientation of the first device. As another example, the state of use behavior of a device can comprise at least one of a user authentication, a type of use, and a time of use, whether the device is actively used while device is moving, etc. In an aspect, the behavior of a device can be monitored by receiving a signal from at least one of motion sensing device associated with the device. As an example, the motion sensing device can comprise a magnetometer, a gyroscope, an accelerometer, and a global positioning system device.

In another aspect, an example system can comprise a remote server and a wireless mobile device in a vehicle. The wireless mobile device can comprise at least one motion sensing device, and a memory and a processor. In an aspect, the memory can be configured for storing signal data from the at least one motion sensing device. The processor can be configured for receiving at least one signal from the at least one motion sensing device; providing data indicating one of driver related safety and mobile device use; and sending the data indicating one of driver related safety and mobile device use to the remote server. In an aspect, the processor can be coupled to the memory.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates an exemplary system environment in which the present methods and systems can operate;

FIG. 2 illustrates various aspects of an exemplary system in which the present methods and systems can operate;

FIG. 3 is a block diagram illustrating an example computing device in which the present systems and methods can operate; and

FIG. 4 is a flowchart illustrating an example method for monitoring a device and a vehicle in which the device is used.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

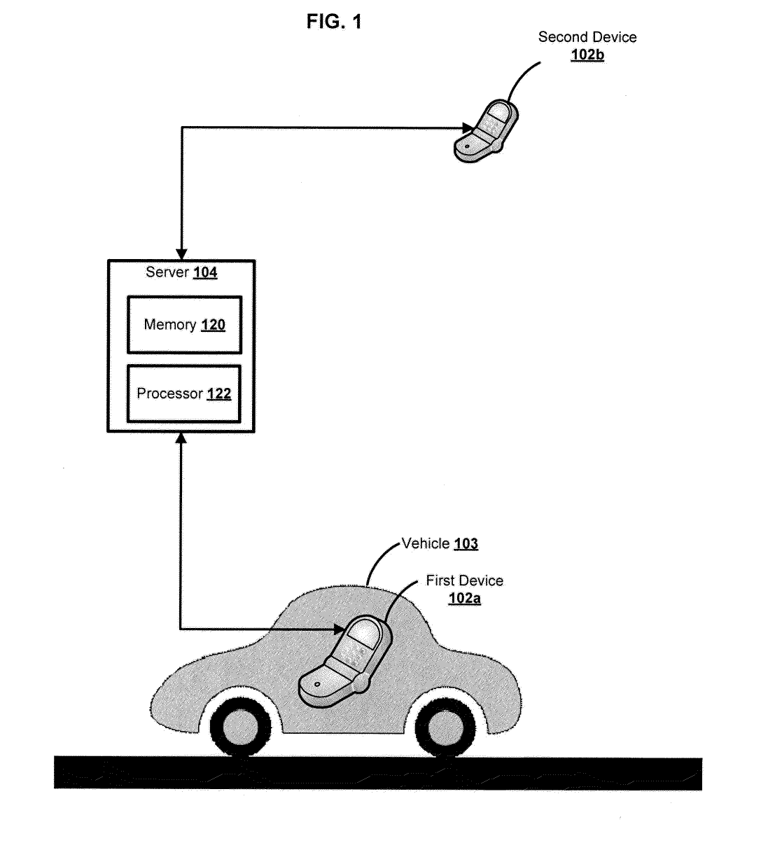

FIG. 1 illustrates an exemplary system environment in which the present methods and systems can operate. As example system can comprise a remote server 104 and a first device 102a (e.g., a wireless mobile device) in a vehicle 103. In an aspect, the first device 102 can comprise at least one motion sensing device, a memory, configured for storing signal data from the at least one motion sensing device and a processor, coupled to the memory, configured for receiving at least one signal from the at least one motion sensing device, providing data indicating one of driver related safety and mobile device use, and sending the data indicating one of driver related safety and mobile device use to the remote server. In an aspect, the data can be sent to a second device 102b.

In an aspect, The remote server 104 can comprise a server memory 120, configured for storing data from the wireless mobile device indicating one of driver related safety and mobile device use, and a server processor 122, coupled to the server memory, configured for: determining if one or more predetermined safety conditions has been met.

In an aspect, the data can comprise real-time data such as position, speed, and acceleration of the device. In another aspect, the data can be used for recording driving behavior of the device user and determining whether such driving behavior violate predetermined safety conditions. These predetermined safety conditions can be set by a party wishing to monitor the driving safety of the monitored device and vehicle. As an example, the predetermined safety conditions can comprise if the device is speeding; if the device is being used for texting (e.g. text messaging, social media activity, internet searching activity; predetermined language usage) while in a moving vehicle; if the device is being used for calling while in a moving vehicle; if the device has left a predefined area of operation; if the device has experienced the occurrence of unsafe driving events (e.g., hard accelerations, hard braking, hard lateral accelerations) and if the wireless mobile device has experienced occurrences of unauthorized uses of the wireless mobile device.

In an aspect, the data can comprise motion behavior and state of use behavior. The motion behavior can comprise the position, speed, acceleration of the device and/or vehicle. The motion behavior can be detected by one or more motion sensor such as magnetometer, gyroscope, accelerometer, global positioning system (GPS) device or other motion sensors associated with a device. In another aspect, the motion behavior can be detected by cellular triangulation. In another aspect, the state of use behavior of a device can comprise device usage such as phone call, text messages, social media activity etc. In an aspect, the motion behavior can be analyzed to exclude extraneous or invalid data. As an example, in determining the correct speed, the stops in traffic or at stoplights can be considered in order to generate accurate speed.

In another aspect, the first device 102a can be configured to have different level of sensitivity depending on to the behavior of the device 102a. As an example, one or more motion sensing device can detect that driving may be beginning, or a significant location change may be about to occur, a GPS device can be set for high sensitivity so the device and the vehicle can be closely monitored. As another example, a motion sensor can detect driving doesn't occur after a pre-defined amount of time (e.g., 10 minutes), GPS sensor can be disabled until another location change is detected. Once driving begins, GPS sensor can be set to at a lower sensitivity to monitor driving. The device can be set to remain in low GPS sensitivity for a predefined time (e.g., 2 minutes) after vehicle stops in order to ensure all data is collected. As a result, battery life of the device can be optimized. As another example, the GPS device can be set to high sensitivity when the device is set to an emergency state so that the device can be located and found.

In an aspect, the first device 102a can be configured to detect a tampering event. For example, the tampering event can comprise disabling a motion sensing device, disconnecting communication with the server, installing a location spoofing application, etc. In another aspect, the first device 102a can be configured for searching device logs and databases for device status and events.

In an aspect, a server 104 can collect the data associated with the behavior of the first device 102a and vehicle 103. As an example, the server 104 can collect data periodically (e.g., once per second, once per minute,), or the first device 102 can accumulate data and then send the data to the server periodically (every few minutes to every hour). In an aspect, the computing device can analyze the data to generate summaries (e.g. trip summaries, state of use summaries), statistics (e.g. averages), indication of event (e.g., speeding, hard acceleration, including hard braking, lateral acceleration) based upon the collected data. In another aspect, the computing device can determine whether to send an alert message to the party who wishes to monitor the vehicle and the state of use of the device 102a. As an example, the parties can be parents of the device 102a user.

In another aspect, the server 104 can collect data from one or more third party sources and compared with data from device 102a in order to determine hazards not detectable from the sensing device associated with the device 102a. For example, the server 104 can receive weather conditions for roads near the location of the vehicle 103, and notify the first device 102a and/or the second device 102b of hazard conditions such as icy roads or severe weather.

In another aspect, the server 104 can combine data from the device 102a, one or more third party sources, and/or historical data of the device 102a in order to provide live event correlation and future data analysis. As an example, collected data data can be used to predict areas known for speeding or violations, frequently flagged dangerous areas, and comparison and regression against a recent behavior of the device 102a and vehicle 103. In an aspect, the collected data can also be used for improvement in performance. For example, statistics of the real-time data (e.g., location data) can be calculated. The calculation can be performed on user-specified terms, for example, calculation for a specific geographic areas or time periods. The calculation can be used to, for example, automatically generate ‘danger’ areas that are based on the frequent setting of that area to be ‘restricted’. A notification can be sent to the first device 102a and second device 102b. In addition, the calculated data can be correlated with the third party data, for example, to determine if supposed unsafe driving may be due to weather conditions, road condition or the like.

In another aspect, a predefined time range can be set up (e.g., by second device 102b) for monitoring. For example, a time range can be set up for ‘quiet hours’, ‘business hours’, etc. During ‘quiet hours’, the server 104 does not monitor the behavior of the first device 102a and vehicle 103. During the ‘business hours’, the server 104 can be available to monitor the device 102a and vehicle 103.

In another aspect, a predefined mode of usage of the device 102a can be set up. For example, a device 102a can be set to ‘passenger mode’. The server 104 can honor ‘passenger mode’ setting from the device 102a. As an example, when ‘passenger mode’ is engaged, the server 104 can be configured for not monitoring the device 102a. In another aspect, when a ‘passenger mode’ is engaged or disabled, the server 104 can send a notification to a second device 102b.

In another aspect, the server 104 can send an email, text message, or a phone call to the second device 102b to alert a party of the occurrence of an unsafe event. As an example, the event can comprise the device 102a is speeding(e.g., exceeding the speed-limit of a given road by a predefined margin), the device 102a is being used for texting (e.g. text messaging, social media activity) while in moving vehicle 103, the device 102a is being used for calling while in moving vehicle 103, the device 102a has left a predefined area of operation (e.g., restricted areas, curfews in geo-fencing), the device 102a has experienced the occurrence of unsafe driving events (e.g., hard accelerations, hard braking, hard lateral accelerations) and the device 102a has experienced occurrences of unauthorized uses, etc.

In an aspect, it can be detected whether the device 102a is in a moving vehicle. For example, based on one or more of speed, location, direction of movement, proximity, motion sensing device sensitivity, type of device and paths of known roads near the device 102a. For example, Moreover, the same detection mechanism can be used to determine whether two or more devices are likely to be in the same vehicle, based on the speed, location, direction of movement, proximity, and paths of known roads near the devices. As an example, the ‘device in vehicle detection’ can be comprise calculating a real time speed threshold based on one or more of location, GPS accuracy, device type, and speed. In an aspect, when the sensitivity of the motion sensing device is high (e.g., less than 10 meter radius for GPS), the speed threshold to determine a moving vehicle can be a low speed (e.g., 10 MPH), whereas when the sensitivity of the motion sensing device is low (e.g., greater than 75 meter radius for GPS), the speed threshold to determine a moving vehicle can be a higher speed (e.g., 20 MPH). The mechanism can be used to reduce the likelihood of incorrect data.

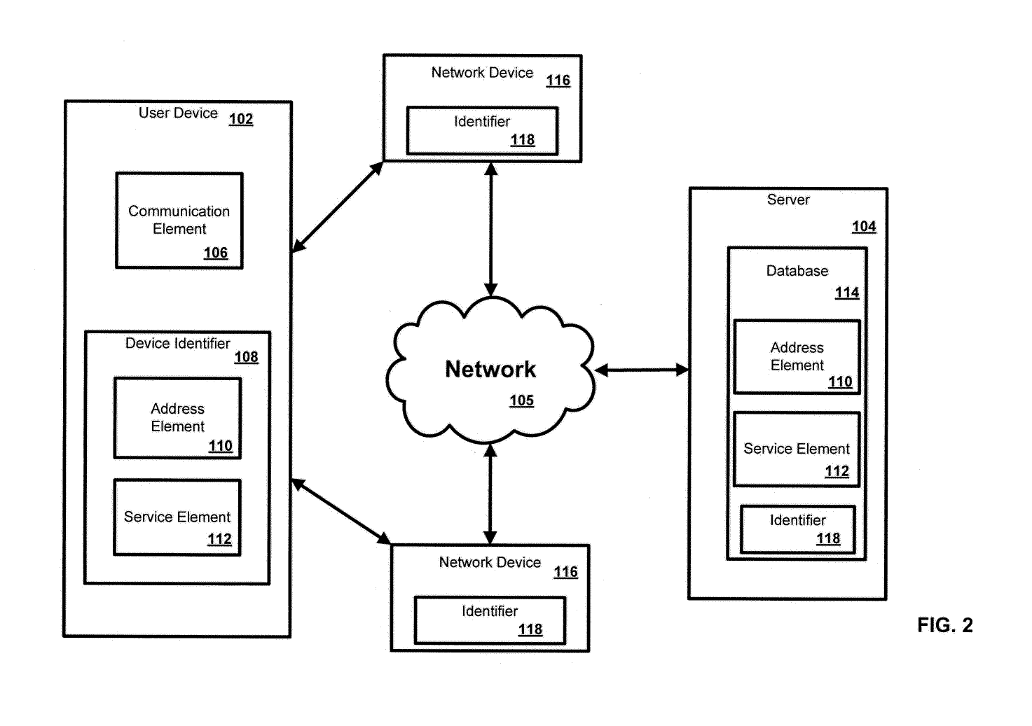

FIG. 2 illustrates various aspects of an exemplary environment in which the present methods and systems can operate. In one aspect of the disclosure, a system can be configured to provide services such as network-related services to a device. By way of example, the server 104 of FIG. 1 can be the computing device 104 of FIG. 2. The first device 102a and second device 102b can be the computing device 104. The present disclosure is relevant to systems and methods for providing services to a device, for example, a user device such as a computer, tablet, mobile device, communications terminal, or the like. In an aspect, one or more network devices can be configured to provide various services to one or more devices, such as devices located at or near a premises. In another aspect, the network devices can be configured to recognize an authoritative device for the premises and/or a particular service or services available at the premises. As an example, an authoritative device can be configured to govern or enable connectivity to a network such as the Internet or other remote resources, provide address and/or configuration services like DHCP, and/or provide naming or service discovery services for a premises, or a combination thereof. Those skilled in the art will appreciate that present methods may be used in various types of networks and systems that employ both digital and analog equipment. One skilled in the art will appreciate that provided herein is a functional description and that the respective functions can be performed by software, hardware, or a combination of software and hardware.

The network and system can comprise a user device 102 in communication with a computing device 104 such as a server, for example. The computing device 104 can be disposed locally or remotely relative to the user device 102. As an example, the user device 102 and the computing device 104 can be in communication via a private and/or public network 105 such as the Internet or a local area network. Other forms of communications can be used such as wired and wireless telecommunication channels, for example.

In an aspect, the user device 102 can be an electronic device such as a computer, a smartphone, a laptop, a tablet, a set top box, a display device, or other device capable of communicating with the computing device 104. As an example, the user device 102 can comprise a communication element 106 for providing an interface to a user to interact with the user device 102 and/or the computing device 104. The communication element 106 can be any interface for presenting and/or receiving information to/from the user, such as user feedback. An example interface may be communication interface such as a web browser (e.g., Internet Explorer, Mozilla Firefox, Google Chrome, Safari, or the like). Other software, hardware, and/or interfaces can be used to provide communication between the user and one or more of the user device 102 and the computing device 104. As an example, the communication element 106 can request or query various files from a local source and/or a remote source. As a further example, the communication element 106 can transmit data to a local or remote device such as the computing device 104.

In an aspect, the user device 102 can be associated with a user identifier or device identifier 108. As an example, the device identifier 108 can be any identifier, token, character, string, or the like, for differentiating one user or user device (e.g., user device 102) from another user or user device. In a further aspect, the device identifier 108 can identify a user or user device as belonging to a particular class of users or user devices. As a further example, the device identifier 108 can comprise information relating to the user device such as a manufacturer, a model or type of device, a service provider associated with the user device 102, a state of the user device 102, a locator, and/or a label or classifier. Other information can be represented by the device identifier 108. As an example, the computing device 104 can associate the first device with the second device by its respective device identifier 108. As another example, the computing device 104 can communicate with a user device 102 by its device identifier 108. As an example, the computing device 104 can associate behavior data from a first user device with its device identifier 108. As another example, the computing device 104 can send a notification to a second user device according to the device identifier 108 of the second device.

In an aspect, the device identifier 108 can comprise an address element 110 and a service element 112. In an aspect, the address element 110 can comprise or provide an internet protocol address, a network address, a media access control (MAC) address, an Internet address, or the like. As an example, the address element 110 can be relied upon to establish a communication session between the user device 102 and the computing device 104 or other devices and/or networks. As a further example, the address element 110 can be used as an identifier or locator of the user device 102. In an aspect, the address element 110 can be persistent for a particular network. As an example, the computing device 104 can associate the first device with the second device by its respective address element 110. As another example, the computing device 104 can identify a device by its address element 110. As another example, address element 110 can be indicative of the location of the respective device.

In an aspect, the service element 112 can comprise an identification of a service provider associated with the user device 102 and/or with the class of user device 102. The class of the user device 102 can be related to a type of device, capability of device, type of service being provided, and/or a level of service (e.g., business class, service tier, service package, etc.). As an example, the service element 112 can comprise information relating to or provided by a communication service provider (e.g., Internet service provider) that is providing or enabling data flow such as communication services to the user device 102. As a further example, the service element 112 can comprise information relating to a preferred service provider for one or more particular services relating to the user device 102. As an example, the service can be the service of monitoring the behavior of the user device 102. In an aspect, the address element 110 can be used to identify or retrieve data from the service element 112, or vice versa. As a further example, one or more of the address element 110 and the service element 112 can be stored remotely from the user device 102 and retrieved by one or more devices such as the user device 102 and the computing device 104. Other information can be represented by the service element 112.

In an aspect, the computing device 104 can be a server for communicating with the user device 102. As an example, the computing device 104 can communicate with the user device 102 for providing data and/or services. As an example, the computing device 104 can provide services such as network (e.g., Internet) connectivity, network printing, media management (e.g., media server), content services, streaming services, broadband services, or other network-related services. In an aspect, the computing device 104 can allow the user device 102 to interact with remote resources such as data, devices, and files. As an example, the computing device can be configured as (or disposed at) a central location (e.g., a headend, or processing facility), which can receive content (e.g., data, input programming) from multiple sources. The computing device 104 can combine the content from the multiple sources and can distribute the content to user (e.g., subscriber) locations via a distribution system.

In an aspect, the computing device 104 can manage the communication between the user device 102 and a database 114 for sending and receiving data therebetween. As an example, the database 114 can store a plurality of files (e.g., web pages), user identifiers or records, or other information. As a further example, the user device 102 can request and/or retrieve a file from the database 114. In an aspect, the database 114 can store information relating to the user device 102 such as the address element 110 and/or the service element 112. As an example, the computing device 104 can obtain the device identifier 108 from the user device 102 and retrieve information from the database 114 such as the address element 110 and/or the service elements 112. As a further example, the computing device 104 can obtain the address element 110 from the user device 102 and can retrieve the service element 112 from the database 114, or vice versa. Any information can be stored in and retrieved from the database 114. The database 114 can be disposed remotely from the computing device 104 and accessed via direct or indirect connection. The database 114 can be integrated with the computing system 104 or some other device or system.

In an aspect, one or more network devices 116 can be in communication with a network such as network 105. As an example, one or more of the network devices 116 can facilitate the connection of a device, such as user device 102, to the network 105. As a further example, one or more of the network devices 116 can be configured as a wireless access point (WAP). In an aspect, one or more network devices 116 can be configured to allow one or more wireless devices to connect to a wired and/or wireless network using Wi-Fi, Bluetooth or any desired method or standard.

In an aspect, the network devices 116 can be configured as a local area network (LAN). As an example, one or more network devices 116 can comprise a dual band wireless access point. As an example, the network devices 116 can be configured with a first service set identifier (SSID) (e.g., associated with a user network or private network) to function as a local network for a particular user or users. As a further example, the network devices 116 can be configured with a second service set identifier (SSID) (e.g., associated with a public/community network or a hidden network) to function as a secondary network or redundant network for connected communication devices.

In an aspect, one or more network devices 116 can comprise an identifier 118. As an example, one or more identifiers can be or relate to an Internet Protocol (IP) Address IPV4/IPV6 or a media access control address (MAC address) or the like. As a further example, one or more identifiers 118 can be a unique identifier for facilitating communications on the physical network segment. In an aspect, each of the network devices 116 can comprise a distinct identifier 118. As an example, the identifiers 118 can be associated with a physical location of the network devices 116.

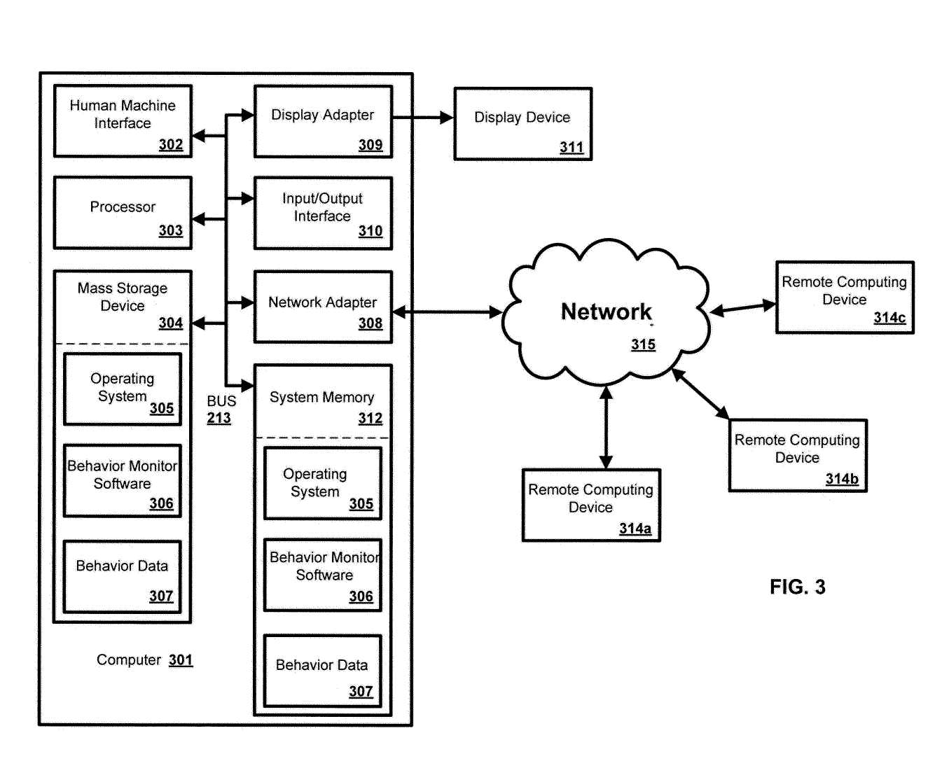

In an exemplary aspect, the methods and systems can be implemented on a computer 301 as illustrated in FIG. 3 and described below. By way of example, device 102a and 102b of FIG. 1 can be a computer 301 as illustrated in FIG. 3. Similarly, the methods and systems disclosed can utilize one or more computers to perform one or more functions in one or more locations. FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 301. The components of the computer 301 can comprise, but are not limited to, one or more processors or processing units 303, a system memory 312, and a system bus 313 that couples various system components including the processor 303 to the system memory 312. In the case of multiple processing units 303, the system can utilize parallel computing.

As an example, the system memory 312 can configured for storing signal data from the at least one motion sensing device associated with the computer 301. The processing units 303 can be configured for receiving at least one signal from the at least one motion sensing device, providing data indicating one of driver related safety and mobile device use, and sending the data indicating one of driver related safety and mobile device use to a remote server such as 314a, b or c.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 313, and all buses specified in this description can also be implemented over a wired or wireless network connection and each of the subsystems, including the processor 303, a mass storage device 304, an operating system 305, behavior monitor software 306, behavior data 307, a network adapter 308, system memory 312, an Input/Output Interface 310, a display adapter 309, a display device 311, and a human machine interface 302, can be contained within one or more remote computing devices 314a,b,c at physically separate locations, connected through buses of this form, in effect implementing a fully distributed system.

The computer 301 typically comprises a variety of computer readable media. Exemplary readable media can be any available media that is accessible by the computer 301 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as behavior data 307 and/or program modules such as operating system 305 and behavior monitor software 306 that are immediately accessible to and/or are presently operated on by the processing unit 303.

In another aspect, the computer 301 can also comprise other removable/non-removable, volatile/non-volatile computer storage media. By way of example, FIG. 3 illustrates a mass storage device 304 which can provide non-volatile storage of computer code, computer readable instructions, data structures, program modules, and other data for the computer 301. For example and not meant to be limiting, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and behavior monitor software 306. Each of the operating system 305 and behavior monitor software 306 (or some combination thereof) can comprise elements of the programming and the behavior monitor software 306. Behavior data 307 can also be stored on the mass storage device 304. Behavior data 307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 303 via a human machine interface 302 that is coupled to the system bus 313, but can be connected by other interface and bus structures, such as a parallel port, game port, an IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 301 can have more than one display adapter 309 and the computer 301 can have more than one display device 311. For example, a display device can be a monitor, an LCD (Liquid Crystal Display), or a projector. In addition to the display device 311, other output peripheral devices can comprise components such as speakers (not shown) and a printer (not shown) which can be connected to the computer 301 via Input/Output Interface 310. Any step and/or result of the methods can be output in any form to an output device. Such output can be any form of visual representation, including, but not limited to, textual, graphical, animation, audio, tactile, and the like. The display 311 and computer 301 can be part of one device, or separate devices.

The computer 301 can operate in a networked environment using logical connections to one or more remote computing devices 314a,b,c. By way of example, a remote computing device can be a personal computer, portable computer, smartphone, a server, a router, a network computer, a peer device or other common network node, and so on. Logical connections between the computer 301 and a remote computing device 314a,b,c can be made via a network 315, such as a local area network (LAN) and/or a general wide area network (WAN). Such network connections can be through a network adapter 308. A network adapter 308 can be implemented in both wired and wireless environments. Such networking environments are conventional and commonplace in dwellings, offices, enterprise-wide computer networks, intranets, and the Internet.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of behavior monitor software 306 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

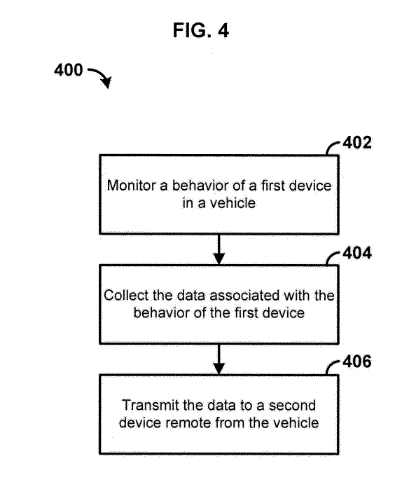

FIG. 4 is a flowchart illustrating an example method for providing content. At step 402, a behavior of a first device in a vehicle can be monitored. In an aspect, the behavior of the first device can comprise one or more of a motion behavior and a state of use behavior. As an example, the motion behavior comprises at least one of a speed, an acceleration, a location, and an orientation of the first device. In an aspect, the behavior of the first device in a vehicle can be monitored by receiving a signal from at least one of a magnetometer, a gyroscope, an accelerometer, and a global positioning system device associated with the first device. In another aspect, the motion behavior can be detected by cellular triangulation.

In an aspect, the state of use behavior can comprise at least one of a user authentication (e.g. if the user is authorized to use the device), a type of use (e.g., calling, text messaging) a time of use (e.g., local time and date, duration of use) and whether the first device is actively used while the vehicle is moving. In an aspect, the state of use behavior can comprise detecting a tampering event. As an example, the tampering event can comprise disabling a motion sensing device, disconnecting communication with the server, installing a location spoofing application, etc.

At step 404, the data associated with the behavior of the first device can be collected. In an aspect, the data can comprise real-time data such as position, speed, acceleration of the device. In an aspect, the data can be collected on a predefined time interval. As an example, the computing device can collect data periodically (e.g., once per second, once per minute,), or the system may accumulate data and then send the data to the server periodically (every few minutes to every hour). In an aspect, the computing device can analyze the data to generate summaries (e.g. trip summaries, state of use summaries), statistics (e.g. averages), indication of event (e.g., speeding, hard acceleration, including hard braking, lateral acceleration) based upon the data. Moreover, the server can determine whether to send an alert message to a party who wishes to monitor the vehicle and the state of use of the device. As an example, the parties can be parents of the mobile device users who have safety concerns for the mobile device user while driving the vehicle.

In another aspect, the server 104 can combine data from the device 102a, one or more third party sources, and/or historical data of the device 102a to provide live event correlation and future data analysis. As an example, collected data data can be used to predict areas known for speeding or violations, frequently flagged dangerous areas, and comparison and regression against a recent behavior of the device 102a and vehicle 103. In an aspect, the collected data can also be used for improvement in performance. For example, statistics of the real-time data (e.g., location data) can be calculated. The calculated data can be correlated with the third party data, for example, to determine if supposed unsafe driving may be due to weather conditions, road condition or the like. In an aspect, the data can be analyzed to exclude extraneous or invalid data. As an example, in determining the correct speed, the stops in traffic or at stoplights can be considered in order to generate accurate speed.

In yet another aspect, the data can be compared with a plurality of predefined conditions. For example, the data can be used for recording driving behavior the device user and determining whether such driving behavior violate pre-defined driving safety conditions. In an aspect, the pre-defined driving safety condition parameters can be set by any party wishing to monitor the driving safety of the monitored vehicle. For example, whether the device has left a pre-determined area. As another example, whether the vehicle exceeded speed limits, hard accelerations, hard braking, hard lateral accelerations, changes in rate level geographical locations. The state of the use of the device can comprise texting (e.g. text messaging, social media activity) while driving (e.g., the vehicle is moving), talking on the device while driving (e.g., the vehicle is moving), unauthorized use of the device, etc. The server could also send a request to the system for information (e.g., real-time information, summaries, or other information).

At step 406, the data can be transmitted to a second device remote from the vehicle. In an aspect, the second device is used by a remote user interested in the behavior of the first device and the vehicle. As an example, the remote server can send an email, text message, or a phone call to another device (e.g., second device) to alert a party of the occurrence of a particular desired event. In an aspect, the event can comprise unsafe driving events, unauthorized uses of the device, etc. As a specific example, the event can comprise exceeding the speed-limit of a given road by a pre-defined margin (e.g., 10 MPH), talking on the device while in a moving vehicle (e.g., moving faster than a pre-defined speed), sending a text message while in a moving vehicle, general changes in location, unauthorized use of the device, etc.

In an aspect, upon transmitting the data to the second device, the server can receive a notification from the second device and transmitting the notification to the first device. For example, the notification can be indicative of stop using the first device. In an aspect, the notification can comprise an override by the second to the operation of the first device. For example, the telephone call or text messaging session can be disabled by the second device.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
monitoring a behavior of a first device in a vehicle;
collecting the data associated with the behavior of the first device; and
transmitting the data to a second device remote from the vehicle.

2. The method of claim 1, wherein the behavior of the first device comprises one or more of a motion behavior and a state of use behavior.

3. The method of claim 2, wherein the motion behavior comprises at least one of a speed, an acceleration, a location, and an orientation of the first device.

4. The method of claim 2, wherein the state of use behavior comprises at least one of a user authentication, a type of use, a time of use, and whether the first device is actively used while the vehicle is moving.

5. The method of claim 2, wherein the state of use comprises detecting a tampering event.

6. The method of claim 1, wherein collecting the data on the behavior of the first device comprises collecting data on a predefined time interval.

7. The method of claim 1, wherein collecting the data on the behavior of the first device comprises analyzing data on the behavior of the first device.

8. The method of claim 7, wherein analyzing the data on the behavior of the first device comprises comparing the data with a plurality of predefined conditions.

9. The method of Claim, wherein collecting the data on the behavior of the first device comprises collecting data from one or more third party sources, wherein the data from one or more third party sources is related to the behavior of the first device.

10. The method of claim 1, wherein the second device is used by a remote user interested in the behavior of the first device and the vehicle.

11. The method of claim 1, further comprises receiving a notification from the second device and transmitting the notification to the first device.

12. The method of claim 1, wherein monitoring the behavior of the first device in a vehicle comprises: receiving a signal from at least one of a magnetometer, a gyroscope, an accelerometer, and a global positioning system device associated with the first device.

13. The method of claim 1, wherein monitoring the behavior of the first device comprises calculating the position of the vehicle by cell tower triangulation.

14. A vehicle movement monitoring system, comprising:
a remote server;
a wireless mobile device in a vehicle, wherein the mobile device comprising:
at least one motion sensing device;
a memory, configured for storing signal data from the at least one motion sensing device; and
a processor, coupled to the memory, configured for:
receiving at least one signal from the at least one motion sensing device;
providing data indicating one of driver related safety and mobile device use; and
sending the data indicating one of driver related safety and mobile device use to the remote server.

15. The vehicle movement monitoring system of claim 14, wherein the at least one motion device comprises at least one of a magnetometer, a gyroscope, an accelerometer, and a global positioning system device.

16. The vehicle movement monitoring system of claim 14, wherein the remote server comprises:
a server memory, configured for storing data from the wireless mobile device indicating one of driver related safety and mobile device use; and
a server processor, coupled to the server memory, configured for determining if one or more predetermined safety conditions has been met.

17. The vehicle movement monitoring system of claim 16, wherein the one or more predetermined safety conditions comprise: if the wireless mobile device is speeding, if the wireless mobile device is being used for texting while in a moving vehicle, if the wireless mobile device is being used for calling while in a moving vehicle, if the wireless mobile device has left a predefined area of operation, if the wireless mobile device has experienced the occurrence of unsafe driving events, and if the wireless mobile device has experienced occurrences of unauthorized uses of the wireless mobile device.

18. The vehicle movement monitoring system of claim 17, wherein the one or more predetermined safety conditions further comprises a preset vehicle or wireless mobile device condition that is set by a third party to monitor a selection safety condition.

19. The vehicle movement monitoring system of claim 17, wherein unauthorized uses of the wireless mobile device can comprise social networking usage, internet searching activity; predetermined language usage, and the like.

20. The vehicle movement monitoring system of claim 16, wherein the remote server configured to send a notification message to a third party when one or more predetermined safety conditions has been met.

21. The vehicle movement monitoring system of claim 14, wherein the mobile wireless device configured for adjusting the sensitivity of the motion sensing device.

22. The vehicle movement monitoring system of claim 14, wherein the remote server configured for received data from one or more third party sources.
